(19) United States
(12) Patent Application Publication
(10) Pub. No.: US 2023/0141764 A1
(43) Pub. Date: May 11, 2023

(54) METHOD FOR ACQUIRING ROAD LOADS

(71) Applicant: ZF Friedrichshafen AG, Friedrichshafen (DE)

(72) Inventor: Dennis Pape, Ostercappeln (DE)

(73) Assignee: ZF Friedrichshafen AG, Friedrichshafen (DE)

(21) Appl. No.: 17/906,564

(22) PCT Filed: Apr. 21, 2021
(86) PCT No.: PCT/EP2021/060292

§ 371 Date: Sep. 16, 2022

(30) Foreign Application Priority Data
May 18, 2020 (DE) 10 2020 206 221.8

(51) Int. Cl. G08G 1/01; G01M 5/00; G07C 5/10

(52) U.S. Cl. CPC G08G 1/0125; G01M 5/0066; G01M 5/0075; G01M 5/0033; G07C 5/10

(57) ABSTRACT

A method for determining road loads includes preparing a road map (15) that contains information about the local configuration of a plurality of roads. For each of a plurality of vehicles (1) a vehicle location is determined and at least one vehicle location signal (So) that characterizes the location of the vehicle concerned is generated. Using the vehicle location signal (So) and the road map, the vehicles (1) are assigned to the roads. For each vehicle (1) a vehicle load mass is determined and at least one vehicle load mass signal (Sm) that characterizes the vehicle load mass is generated. At least one road loading signal (Sb) that characterizes a road load is generated for each road using the vehicle load mass signals (Sm) of the vehicles (1) assigned to it.

### RELATED APPLICATIONS

This application claims the benefit under 35 U.S.C. § 371 as a U.S. National Application of application no. PCT/EP2021/060292, filed on 21 Apr. 2021, which claims benefit of German Patent Application no. 10 2020 206 221.8 filed 18 May 2020, the contents of which are hereby incorporated herein by reference in their entireties.

### FIELD OF THE DISCLOSURE

The invention relates to a method for determining road loads.

### BACKGROUND

Cities or municipalities often do not know how severely their roads are loaded. To obtain information about the loading of roads, one approach is to implant pressure sensors in the streets. However, such sensors are very expensive. Moreover, replacing the pressure sensors is costly.

### SUMMARY

Starting from there, the purpose of the present invention is to provide an inexpensive option for the determination of road loads.

According to the invention, this objective is achieved by a method according to Claim 1. Preferred further developments of the method are indicated in the subordinate claims and in the description given below.

A method for determining road loads is in particular further developed in that:
a. a road map is prepared, which contains information about the local configuration of several roads,
b. for a number of vehicles, in each case a specifically current vehicle location is determined, preferably automatically, and at least one vehicle location signal that characterizes that vehicle location is generated,
c. the vehicles are associated with the roads by using and/or evaluating the vehicle location signals and the road map, preferably automatically,
d. for each vehicle a specifically current vehicle load mass is determined, preferably automatically, and at least one vehicle load mass signal that characterizes the mass of that vehicle load is generated, and
e. for each road, using and/or evaluating the vehicle load mass signals of the vehicles associated with that road, preferably automatically, at least one road load signal that characterizes the road load specifically caused by the said vehicles and/or their vehicle load masses, in particular the loading of the road concerned, is generated.

This enables road loads to be determined. Since the sensor systems used to carry out the method are as a rule already present in current vehicles, the costs can also be kept relatively low.

Preferably, in particular by using and/or by evaluating the vehicle location signals and the road map, the vehicles are associated with those roads on the local paths of which the vehicle locations of the vehicles lie. Preferably, in particular by using and/or by evaluating the vehicle location signal concerned and the road map, each vehicle is associated with one road or with those among the roads on the local path of which the vehicle location of the vehicle concerned lies. Advantageously, in particular by using and/or by evaluating its vehicle location signal and the road map, at least one of the vehicles is associated with one road or with those among the roads on the local path of which the vehicle location of the at least one vehicle concerned lies.

According to a further development, each vehicle has a load mass determination unit by means of which the mass of the vehicle load of the vehicle concerned is determined, and at least one vehicle load mass signal is generated and/or emitted. Preferably, in at least one or in several or in each of the vehicles the load mass determination unit forms or comprises at least one height level sensor, by means of which a suspension spring deflection of the at least one, or of the vehicle concerned is preferably detected. The suspension spring deflection depends on the mass of the vehicle load. Thus, a height level sensor is suitable for determining the mass of the vehicle load. Moreover, a height level sensor is already present in many vehicles. In addition, or alternatively, at least one or at least one other of the vehicles has a pneumatic suspension system, in particular containing a gaseous suspension medium. In that case the load mass determination unit of the vehicle concerned comprises at least one pressure sensor by means of which, for example, the pressure of the suspension medium is determined. The pressure of the suspension medium depends on the mass of the vehicle load. Thus, the pressure sensor is suitable for determining the vehicle load mass. The suspension medium is preferably air, in particular compressed air.

In one embodiment, each vehicle has a locating unit by means of which, for the vehicle concerned, the vehicle location is determined and which generates and/or emits at least one vehicle location signal. Preferably, in at least one or in each vehicle the location unit forms or comprises a global positioning system (GPS) by means of which, preferably, the global position of the at least one vehicle, or that of the vehicle concerned, is determined.

According to a further development, the at least one road load signal pertaining to each road, or the road load signals, are generated by an evaluation unit. The evaluation unit is preferably in communicating connection, preferably by wireless means or radio link, with the load mass determination unit and/or with the location unit. Advantageously, the evaluation unit communicates with the load mass determination unit and/or with the location unit of each vehicle, in particular by wireless means, for example by radio. Preferably, the evaluation unit is and/or can be connected in particular by wireless means, for example by radio, with the load mass determination unit of each vehicle and/or with the location unit of each vehicle. In particular, the evaluation unit is provided and/or arranged a distance away and/or remotely from the vehicles.

The evaluation unit preferably comprises a receiver unit by means of which, in particular, the vehicle location signals and the vehicle load mass signals are or can be received, preferably by wireless means and/or by radio. Advantageously, the evaluation unit comprises a computer unit by means of which, in particular, the vehicle load signals are and/or can be generated. Preferably, the evaluation unit also comprises a memory unit in which, in particular, the road map or the road-map-characterizing road map information is stored.

The road map is preferably present in electronic form and/or in the form, in particular, of electronic data and/or in the form of software. Advantageously, it is an electronic road map. Preferably, the road map is stored in the memory unit or a memory unit. Advantageously, the evaluation unit contains the memory unit.

Each vehicle preferably contains a transmitter unit by means of which, in particular, the at least one vehicle location signal and the at least one vehicle load mass signal of the vehicle concerned is or can be transmitted to the evaluation unit and/or to its receiver unit, in particular by wireless means and/or by radio. The transmitter unit of each vehicle is preferably connected with the load mass determination unit and the location unit of the vehicle concerned.

Preferably, by each vehicle and/or by means of the transmitter unit of each vehicle, at least one vehicle information signal, in particular pertaining to the said vehicle, is or can be transmitted to the evaluation unit and/or to its receiver unit, in particular by wireless means and/or by radio. Advantageously, at least one, or the at least one vehicle information signal from each vehicle is and/or can be received by the evaluation unit and/or its receiver unit, preferably by wireless means and/or by radio. The at least one vehicle information signal from each vehicle preferably contains the at least one vehicle location signal and the at least one vehicle load mass signal of the vehicle concerned.

Preferably, an empty vehicle mass signal is associated with each vehicle, which preferably characterizes the mass of the vehicle concerned in the empty and/or unloaded condition. A vehicle in the empty and/or unloaded condition is, in particular, also referred to as an empty vehicle. Preferably, for each vehicle the empty vehicle mass signal is generated and/or emitted and/or stored. Advantageously, by using and/or evaluating for each road the vehicle load mass signals of the associated vehicles and the empty vehicle mass signals of the associated vehicles, the at least one road load signal is generated. Preferably, for each road the at least one road load signal is additionally generated by using and/or by evaluating the empty vehicle mass signals of the associated vehicles. In that way, not only the vehicle load masses but also the empty vehicle masses can be taken into account. The empty vehicle mass signal of each vehicle is for example stored in the memory unit of the evaluation unit, and/or it is stored and/or recorded in the respective vehicle itself and/or, for example by means of the transmitter unit of the said vehicle, it is and/or can be transmitted to the evaluation unit, preferably by wireless means and/or by radio. Preferably, the at least one vehicle information signal from each vehicle also contains the empty vehicle mass signal of the vehicle concerned.

Preferably, each vehicle is associated with a specific and unambiguous vehicle identification datum. The vehicle identification datum of each vehicle is for example stored in the memory unit of the evaluation unit, and/or it is stored and/or recorded in the respective vehicle itself and/or, for example by means of the transmitter unit of the said vehicle, it is and/or can be transmitted to the evaluation unit, preferably by wireless means and/or by radio. Advantageously, each vehicle identification datum stored in the memory of the evaluation unit is associated with the related empty vehicle mass signal. Preferably, the at least one vehicle information signal of each vehicle contains, in particular additionally, the vehicle identification datum of the vehicle concerned.

The vehicles are, in particular, motor vehicles. Preferably, the vehicles are prepared. Preferably, the vehicles or several of the vehicles are driving on the roads.

In one embodiment, for at least one of the roads, a road-surfacing material is selected from a plurality of different road-surfacing materials as a function of the associated at least one road load signal. Preferably the road-surfacing material chosen, in particular subsequently, is used and/or adopted as the material for the road-surfacing of the said at least one road. Thus, the material of the road-surfacing can be selected appropriately for the load. Advantageously, the different road-surfacing materials are appropriate for different road loads.

According to a further development, at least one of the vehicles has a vibration detection unit by means of which at least one vehicle vibration of the at least one vehicle is detected and at least one vehicle vibration signal that characterizes this vehicle vibration is generated. Preferably, the said at least one vehicle vibration signal is compared with a predefined reference vibration signal, and depending on the result of the comparison, at least one road wear signal that characterizes the wear condition of the road with which the vehicle is associated, is generated. In that way, for example, the wear condition of the said road can be determined. Preferably the vibration detection unit is formed by the load mass determination unit of the at least one vehicle. For example, the vibration detection unit is formed by at least one or by the at least one height level sensor of the at least one vehicle. Alternatively, the vibration detection unit is formed by at least one or by the at least one pressure sensor of the at least one vehicle, specifically when the vehicle has pneumatic suspension.

Preferably, the at least one vehicle vibration signal is compared by the evaluation unit with the at least one predefined reference vibration signal, Preferably, depending on the result of the comparison, the at least one road wear signal is generated by the evaluation unit. Advantageously the at least one vehicle vibration signal is or can be transmitted to the evaluation unit, in particular by the transmitter unit, preferably by wireless means and/or by radio. Preferably, the at least one vehicle information signal of the at least one vehicle additionally contains, in particular, the at least one vehicle vibration signal of the at least one vehicle.

The at least one predefined reference vibration signal of the at least one vehicle is for example stored in the memory unit and/or is stored and/or recorded in the at least one vehicle and/or is or can be transmitted to the evaluation unit by means of the transmitter unit of the at least one vehicle, preferably by wireless means and/or by radio. Advantageously, the vehicle identification information of the at least one vehicle stored in the memory is associated with the pertinent at least one predefined reference vibration signal.

### BRIEF DESCRIPTION OF THE DRAWINGS

Below, the invention is described with reference to a preferred embodiment, referring also to the drawing, which shows:

FIG. 1: A schematic representation of a vehicle and an evaluation unit, and

FIG. 2: A more detailed representation of the evaluation unit.

### DETAILED DESCRIPTION

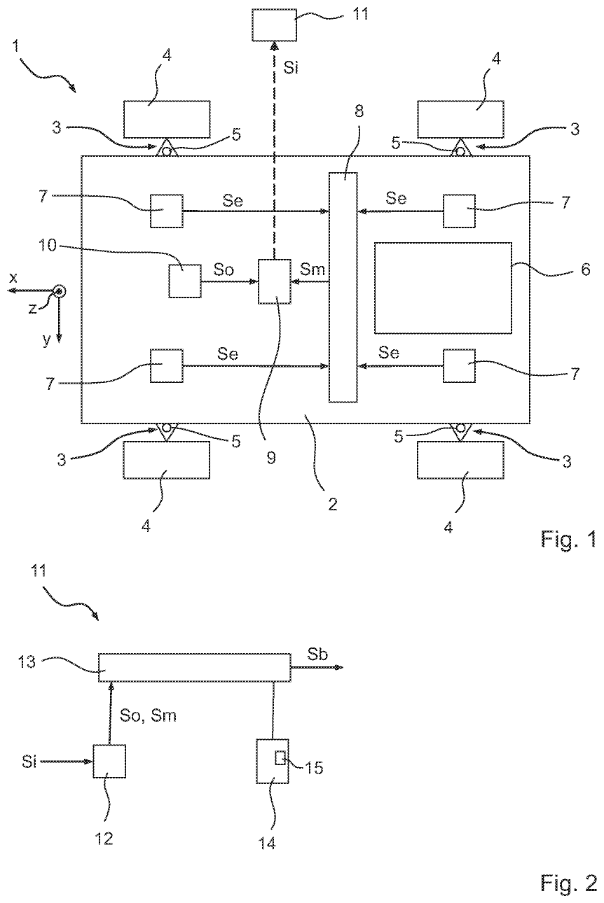

FIG. 1 shows a schematic representation of a vehicle 1 comprising a vehicle body 2 and a number of vehicle wheels 4 connected to the vehicle body 2 by means of wheel suspensions 3, the wheels further being supported on the vehicle body 2 in a vertical direction z of the vehicle by schematically indicated vehicle springs 5. In FIG. 1 the vertical direction z of the vehicle 1 extends in particular perpendicularly to the plane of the drawing. Furthermore a longitudinal direction x of the vehicle and a transverse direction y of the vehicle are shown, wherein the directions x, v, and z in that sequence form in particular a co-ordinate system. The usual forward-driving direction of the vehicle 1 preferably extends in the longitudinal direction x of the vehicle.

The vehicle body carries a vehicle load 6, whose mass is also called the vehicle load mass. This mass results is a deflection of the vehicle wheels 4 relative to the vehicle body 2 in the vertical direction z of the vehicle, which deflection of the vehicle wheels 4 is detected by a number of height level sensors 7. The height level sensors 7 are connected to a load mass determination unit 8 by means of which, from deflection signals Se delivered by the height level sensors 7, the vehicle load mass is determined and a vehicle load mass signal Sm is generated and sent to a transmitter unit 9. The height level sensors 7 are preferably part of the load mass determination unit 8. Although it is preferable to have several, for example three or four height level sensors 7, it is also possible to us only one or two height level sensors 7. For that reason, in particular at least one height level sensor 7 is provided.

The vehicle 1 further comprises a location unit 10, by means of which the location of the vehicle 1 is determined and a vehicle location signal So is generated and sent to the transmitter unit 9. The location of the vehicle 1 is in particular also called the vehicle location. The height level sensor or sensors 7. the load mass determination unit 8. the transmitter unit 9 and the location unit 10 are provided on or in the vehicle.

The transmitter unit 9 transmits a vehicle information signal Si to an evaluation unit 11 provided at a distance from the vehicle 1, as can be seen in the more detailed representation in FIG. 2. The vehicle information signal Si includes in particular the vehicle load mass signal Sm and the vehicle location signal So.

The evaluation unit 11 includes a receiver unit 12 by which the vehicle information signal Si can be received, a computer unit 13 and a memory unit 14, in which a road map 15 is stored in electronic form, the said map giving information about the local configurations of several roads.

By means of the computer unit 13 the vehicle 1 is assigned to one of the roads by evaluating the vehicle location signal So and with reference to the road map. Preferably, additional vehicles are assigned to this road in a corresponding manner. Thereafter, by means of the computer unit 13. by evaluating for the said road the vehicle load mass signals Sm of the vehicles 1 assigned to the road concerned, a road load signal Sb that characterizes the road loading of the said road is generated.

Preferably the evaluation unit 11 receives corresponding vehicle information signals from other vehicles, these vehicles driving on other roads. In that case corresponding road loading signals can be generated for the other roads.

### INDEXES

1 Vehicle
2 Vehicle body
3 Wheel suspension
4 Vehicle wheel
5 Vehicle suspension spring
6 Vehicle load
7 Height level sensor
8 Load mass determination unit
9 Transmitter unit
10 Location unit
11 Evaluation unit
12 Receiver unit
13 Computer unit
14 Memory unit
15 Road map
Se Suspension spring deflection signal
Sm Vehicle load mass signal
So Vehicle location signal
Si Vehicle information signal
Sb Road loading signal
x Longitudinal direction of the vehicle
y Transverse direction of the vehicle
z Vertical direction of the vehicle

1-11. (canceled)

12. A method for determining road loads, the method comprising:
preparing a road map (15) is prepared, the road map containing information about local configurations of a plurality of roads;
determining a vehicle location for each of a plurality of vehicles (1)
generating at least one vehicle location signal (So) for the plurality of vehicles, the vehicle location signal characterizing the vehicle location;
assigning each of the plurality of vehicles (1) to one or more roads of the plurality of roads using the vehicle location signals (So) and the road map;
generating at least one vehicle load mass signal (Sm) for each of the plurality of vehicles (1), the at least one vehicle load mass signal characterizing a vehicle load mass; and
generating at least one road loading signal (Sb) for each road of the plurality of roads, using the at least one vehicle load mass signal (Sm) for each of the plurality of vehicles (1), the at least one road loading signal (Sb) characterizing a road load.

13. The method according to claim 12, wherein each vehicle (1) contains a load mass determination unit (8), wherein determining the vehicle load mass and generating the at least one vehicle load mass signal (Sm) are performed using the load mass determination unit (8).

14. The method according to claim 13, wherein in at least one of the vehicles (1) the load mass determination unit (8) comprises at least one height level sensor (7), by means of which a spring deflection of the vehicle (1) is determined.

15. The method according to claim 13, wherein at least one of the plurality of vehicles (1) has pneumatic suspension comprising a gaseous suspension medium, wherein the load mass determination unit (8) of the at least one of the plurality of vehicles contains at least one pressure sensor by means of which a pressure of the suspension medium is determined.

16. The method according to claim 15, wherein each vehicle (1) contains a location unit (10), and wherein the method further comprises:
determining, by the location unit, the vehicle location of each of the plurality of vehicles (1); and
generating, by the location unit, at least one vehicle location signal (So).

17. The method according to claim 16, wherein in at least one of the plurality of vehicles (1) the location unit (10) comprises a global positioning system, and wherein the method further comprises determining a global position of the at least one of the plurality of vehicles by means of the global positioning system.

18. The method according to claim 17, comprising:
providing an evaluation unit (11) remotely from the plurality of vehicles, the evaluation unit connected by radio to the road load mass determination unit (8) and to the location unit (10); and
generating the at least one road loading signal (Sb) by means of the evaluation unit (11).

19. The method according to claim 12, comprising:
associating an empty vehicle mass signal is associated with each of the plurality of vehicles (1), the empty vehicle mass signal characterizing a mass of a vehicle of the plurality of vehicles, in an unloaded condition; and
generating, for each road, the at least one road loading signal (Sb) using the empty vehicle mass signal of one or more respective vehicles of the plurality of vehicles.

20. The method according to claim 12, comprising:
selecting, for at least one road of the plurality of roads, a road-surfacing material from a plurality of different road-surfacing materials as a function of the associated at least one road loading signal (Sb), wherein the road-surfacing material is used as the road-surfacing material of the at least one road.

21. The method according to claim 12, wherein at least one of the plurality of vehicles (1) comprises a vibration detecting unit, and wherein the method comprises:
detecting, by the vibration detecting unit, at least one vehicle vibration of the at least one vehicle (1) and;
generating, by the vibration detecting unit, at least one vehicle vibration signal that characterizes the at least one vehicle vibration, comparing the at least one vehicle vibration signal with a predefined reference vibration signal; and
determining, based on the comparison, at least one road wear signal that characterizes a wear condition of the road with which the at least one vehicle (1) is associated.

22. The method according to claim 21, wherein the vibration detecting unit is formed by the load mass determination unit (8) of the at least one vehicle (1).
